(19) United States
(12) Patent Application Publication
(10) Pub. No.: US 2005/0033746 A1
(43) Pub. Date: Feb. 10, 2005

(54) Method and apparatus for multiple language web content management

(76) Inventors: Li-Wen Chao, Shindian City (TW); Ying-Cheng Yeh, Shindian City (TW); Chih-Hung Chiu, Shindian City (TW)

Correspondence Address: RABIN & Berdo, PC, 1101 14TH STREET, NW, SUITE 500, WASHINGTON, DC, 20005, US

(21) Appl. No.: 10/804,131

(22) Filed: Mar. 19, 2004

(30) Foreign Application Priority Data
Jul. 21, 2003 (TW) 92119777

(51) Int. Cl. G06F 17/30

(52) U.S. Cl. 707/10

(57) ABSTRACT

A method of multiple language web content management. The method is suitable for use in a system including at least one web server, at least one language database and a management interface. The web server first links to the language database corresponding to the language type of the web content, and obtains the dynamic data corresponding to the language type from the language database. The dynamic data and the static data are then combined, and displayed as web content by the web server. The dynamic data can be modified through the management interface, and the modified dynamic data is stored in the corresponding language database according to its language type, and is displayed by the web server.

### BACKGROUND OF THE INVENTION

1. Field of the Invention

The present invention relates to web content management, and in particular to a method and apparatus for managing multiple language web content.

2. Description of the Related Art

An enterprise may provide information on websites in different languages. It is important to maintain the consistency between websites in different locations, which means providing accurate information to different countries in their respective language. For example, an enterprise may have web servers in different locations, and content may be displayed in Chinese, English, and Japanese, respectively. When product information updated, an effective mechanism for updating the product information in several languages is necessary.

Conventionally several management interfaces in the respective language are used to update web content. That is specific management interface is designed for a specific language. For example, three management interfaces are provided to maintain web content in Chinese, English, and Japanese, respectively.

Conventional management mechanisms waste resources by maintaining several management interfaces corresponding to different languages. In some situations, the information may be different for each website, for example, the Chinese language product information may be different from English language product information. Conventional management mechanisms cannot effectively updated and maintain content of this type. Maintenance personnel must log into different management interfaces to maintain corresponding web content, potentially resulting in inconsistencies and duplications.

### SUMMARY OF THE INVENTION

Accordingly, the present invention provides an apparatus and a method that employs an integrated management interface for simultaneous maintenance of multiple language web content.

The present invention provides an apparatus and a method that dynamically links to a database and retrieves corresponding data from a database to maintain web content.

The present invention provides a method and an apparatus of multiple language web content management. According to one embodiment of the invention, the apparatus includes at least one web server, at least one language database and one and only one management interface, and the method according to another embodiment of the invention is suitable for use in a system including at least one web server, at least one language database and a management interface.

The management interface receives a language type, to be displayed on the website or stored on the database server. The web server displays web content including both static data and dynamic data. The static data indicates the constant web content, such as navigation elements, or other data that changes infrequently, such as company history. Static data is stored on the web server, and written in the specific language used by the web server as it changes infrequently. Dynamic data indicates web content, such as product and service information, that is frequently modified through the management interface. The language database corresponds to a language type, and stores dynamic data corresponding to the language type. The web server corresponds to one or several language databases according to content it displays.

The web server first links to the language database corresponding to the language type of the web content, such as English web content, Chinese web content and Japanese web content, and obtains the dynamic data corresponding to the language type from the language database. For example, Chinese web content is acquired by the web server using Chinese. Then, the dynamic data and the static data are combined, and displayed as web content by the web server.

Dynamic data can be modified through the management interface. The modified dynamic data is stored in the corresponding language database according to its language type, to be used by the web server. If the management interface is on the web server, the web server may modify data through the management interface and store the modified data to the language database. If the management interface is on the database server, the data stored in the language database can be directly modified through the management interface. Clearly, the invention does not limit the location of the management interface.

The above-mentioned method may take the form of program code embodied in a tangible media. When the program code is loaded into and executed by a machine, the machine becomes an apparatus for practicing the invention.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a flowchart showing the process of the method of multiple language web content management according to the present invention; and

FIG. 2 is a schematic diagram illustrating the architecture of the apparatus of multiple language web content management according to the present invention.

### DETAILED DESCRIPTION OF THE INVENTION

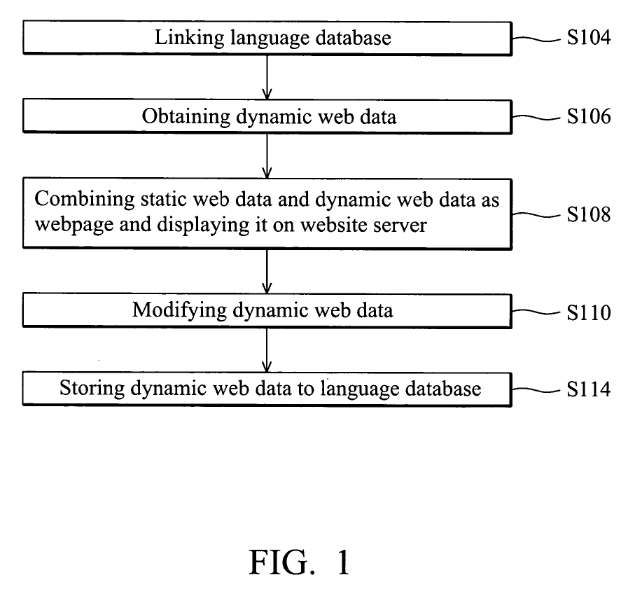

FIG. 1 shows the process of the method of multiple language web content management according to one embodiment of the present invention. The method of multiple language web content management is suitable for use in a system including web servers, language databases and a management interface. Each web server may display web content including static data and dynamic data corresponding to its language type, in which the static data is stored on the web server. The management interface can be used to modify the dynamic data. Each language database corresponds to one language type, and stores the dynamic data corresponding to the language type. The language databases can be stored in a single database server, or in several database servers according to its size.

The web server first links to one of the language databases according to the language type of the web content to be displayed (Step S104), and obtains the dynamic data corresponding to the language type from the language database (Step S106). The dynamic data and the static data are then combined, and displayed as web content by the web server (Step S108).

If the dynamic data requires modification and/or update, it can be modified through the management interface (Step S110), and the modified dynamic data is stored in the corresponding language database according to its language type (Step S114). The modified dynamic data can then be transmitted to the corresponding web server.

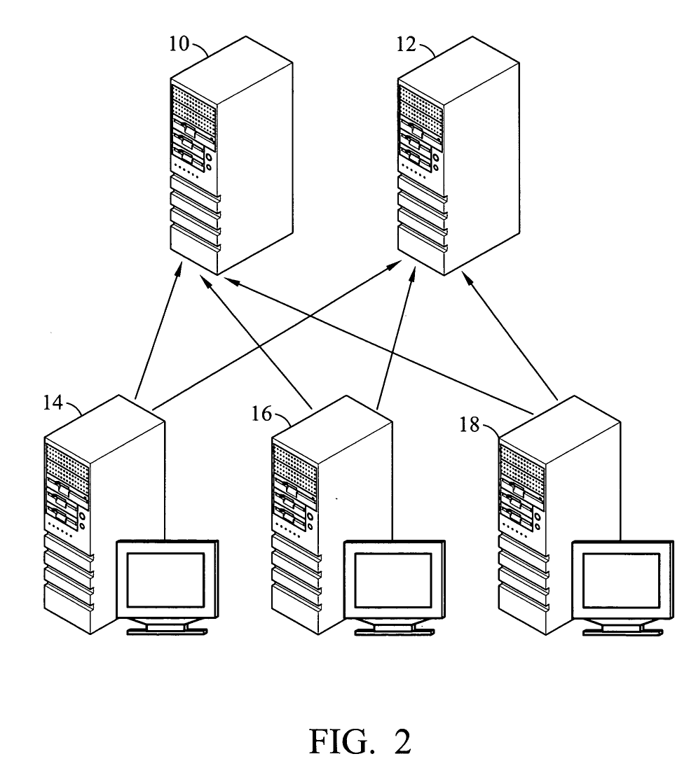

FIG. 2 illustrates the architecture of the apparatus of multiple language web content management according to another embodiment. The apparatus includes database servers 10 and 12, a management interface (not shown in FIG. 2), and web servers 14, 16 and 18. Each of the database servers 10 and 12 includes a language database, and each language database stores the dynamic data corresponding to one language type.

The web servers 14, 16 and 18 display static and dynamic data corresponding to respective language types. The static data is written in the language type used by each web server, and stored in respective web servers. Each web server respectively links to a corresponding language database according to its language type, obtains the dynamic data corresponding to the language type, and combines the dynamic and static data, and then displays the combined result. Each web server and/or each database server may modify the dynamic data through the management interface, and store the modified dynamic data to the corresponding language database according to its language type, so that the dynamic data can be used by the web server. It should be note the modified dynamic data can also be translated to other language types and stored in other language databases. However, the translation among different languages is not the main character of the invention.

For example, an enterprise may have web servers 14, 16, and 18 displaying Chinese, English, and Japanese, content respectively. That is, the web server 14 displays Chinese web content, web server 16 displays English web content, and web server 18 displays Japanese web content. Essentially, each of the web content includes static and dynamic data, in which the static data is written in the language type used by each web server, and stored on respective web servers. The static data in Chinese is stored on web server 14, the static data in English is stored on web server 16, and the static data in Japanese is stored on web server 18. The system additionally includes three language databases for Chinese, English, and Japanese, respectively. The language databases store the dynamic data corresponding to Chinese, English, and Japanese, respectively. The language database for Chinese can be stored in a first database server 10, and the language databases for English and Japanese can be stored in a second database server 12.

The management interface can be located in both the web servers and the database servers. If the management interface is on the web server 14, the web server 14 may receive messages and data input from the management interface. If a user selects Japanese as the language type, the web server 14 links to the second database server 12, to obtain the dynamic Japanese data, for display on the management interface.

The dynamic Japanese data can be modified by the user, and the modified dynamic data can be stored in the Japanese language database on the second database server 12. Similarly, the dynamic English data can be modified through the management interface on the web server 14, and the modified dynamic data can be stored in the English language database on the second database server 12.

According to another embodiment of the present invention, a storage medium for storing a computer application providing the method of multiple language web content management. The computer application comprises a storage medium having computer readable program code embodied in the medium for use in a computer system. The storage medium comprises the following: a first program code for linking to at least one language database having dynamic data in a specific language type and storing at least one dynamic data in the specific language type; a second program code for modifying the dynamic data via a management interface; and a third program code for transmitting the dynamic data, especially the modified dynamic data, to the web server in the specific language type. The storage medium further comprises a fourth program code for combining and displaying the static data and the dynamic data on the web server. Of course, as mentioned above, the management interface could be located on at least one web server, the language database could be stored on at least one database server, and the management interface could be located on at least one database server.

As described above, since the static data is stored on the web server and the dynamic data is stored on the database server, the present invention can use an integrated management interface to maintain the dynamic data by linking to a corresponding database server, and the web server may obtain updated information by linking to a corresponding database server. It is understood that the dynamic data update can be performed from the web server or the database server.

For example, if a product version is updated, the updated product can be stored on the database server and distributed through the web server by dynamically linking to the database server, thereby preventing duplicated effort and excessive resource consumption.

As a result, the present invention provides an apparatus and method that employs an integrated management interface to simultaneously maintains web content indifferent languages, and dynamically links to a database to retrieve corresponding data from the database for web content maintenance.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. A method of multiple language web content management, comprising the steps of:
providing at least one web server, at least one language database and a management interface, wherein each web server corresponds to at least one language and displays at least a static data and a dynamic data, each static data being stored in the corresponding web server, each language database corresponding to a specific language and storing all dynamic data in specific language type;
modifying the dynamic data via the management interface; and
linking each web server to language databases with same language, such that the web server acquires corresponding dynamic data.

2. The method as claimed in claim 1 further comprising combining and displaying the static and dynamic data by the web server.

3. The method as claimed in claim 1 further comprising the following steps:
amending at least one dynamic data via the management interface while the amended dynamic data required to be updated; and
storing the amended dynamic data to at least one language database corresponding to the same language of the amended dynamic data.

4. The method as claimed in claim 1 wherein the management interface is on at least one of the web servers.

5. The method as claimed in claim 1 wherein the management interface is on at least one server including at least one language database.

6. The method as claimed in claim 1 wherein each of the language database could be stored on at lease one web server.

7. The method as claimed in claim 6 wherein the management interface is on the web server that includes the language database.

8. The method as claimed in claim 1 wherein the language database is stored on a database server.

9. The method as claimed in claim 8 wherein the management interface is on the database server.

10. The method as claimed in claim 1 wherein each web server corresponds only to one specific language type.

11. An apparatus of multiple language web content management, comprising:
at least one database server, each database server including at least one language database, each language database corresponding to a specific language and storing at least one dynamic data in the specific language type;
a management interface to modify the dynamic data; and
at least one web server coupled with at least one database server and to display both the static data and the dynamic data, the static data being stored in the web server, the dynamic data being stored in the language database and are acquired by the web server.

12. The apparatus as claimed in claim 11 wherein the management interface is on at least one web server.

13. The apparatus as claimed in claim 11 wherein the management interface is on at least one database server.

14. The apparatus as claimed in claim 11 wherein each web server further combines and displays the static data and the dynamic data.

15. The apparatus as claimed in claim 11 wherein the management interface further transfers the modified dynamic data in the specific language type and stores it in the language database while the modified dynamic data needed to be updated.

16. The apparatus as claimed in claim 11 wherein the management interface further transfers the modified dynamic data in the specific language type and stores it in the web server while the modified dynamic data needed to be updated.

17. A machine-readable storage medium storing a computer program which when executed causes a computer to perform a method of web content management for use in a web server having static data, comprising:
a first program code for linking to at least one language database having dynamic data in a specific language type and storing at least one dynamic data in the specific language type;
a second program code for modifying the dynamic data via a management interface; and
a third program code for transmitting the dynamic data, especially the modified dynamic data, to the web server in the specific language type.

18. The storage medium as claimed in claim 17 further comprising a fourth program code for combining and displaying the static data and the dynamic data on the web server.

19. The storage medium as claimed in claim 17 wherein the management interface is on at least one web server.

20. The storage medium as claimed in claim 17 wherein the language database is stored on at least one database server, and the management interface is on at least one database server.
